(19) United States
(12) Patent Application Publication
(10) Pub. No.: US 2007/0011065 A1
(43) Pub. Date: Jan. 11, 2007

(54) Method and system for pre-funding with merger call flexibility

(76) Inventors: Santosh Sreenivasan, New York, NY (US); Stephen M. Barral, Bernardsville, NJ (US); Jeffrey J. Zajkowski, Short Hills, NJ (US)

Correspondence Address: MILBANK, TWEED, HADLEY & MCCLOY, 1 CHASE MANHATTAN PLAZA, NEW YORK, NY, 10005-1413, US

(21) Appl. No.: 11/176,535

(22) Filed: Jul. 7, 2005

(51) Int. Cl. G06Q 40/00

(52) U.S. Cl. 705/35

(57) ABSTRACT

A system and method for acquisition funding comprising identifying a time period associated with a contingent acquisition, and issuing a convertible security to finance the acquisition. The convertible security has a redemption right that is exercisable by an issuer of the convertible security within the time period and upon termination of the contingent acquisition. Within the time period, the system and method determine whether the contingent acquisition is terminated, and responsive to determining whether the contingent acquisition is terminated, the system and method redeem the convertible security.

### BACKGROUND

1. Field of the Invention

The invention relates to the field of corporate financing, and more particularly to funding of mergers or contingent acquisitions.

2. Description of the Related Art

Systems and methods for funding through convertible bonds and securities are known. In those known systems and methods, companies issue convertibles to investors with or without the ability to redeem (call) the convertible before its maturity at a predetermined price. The issuance of convertibles, rather than straight equity or debt, allows companies to fulfill a number of financing objectives including the obtainment of fast, low-cost funding and the enjoyment of certain tax advantages.

To support a merger or acquisition, a company may need to secure a sizable level of funding over a relatively short period of time, and if the merger or acquisition is successful, the funds are needed to close the deal. However, if the merger or acquisition terminates, or does not close, then the contingent funding is no longer needed and the company needs a way to get out of the commitments at minimal cost.

Systems and methods are needed that use convertible bonds in such a pre-acquisition or contingent acquisition.

The preceding description is not to be construed as an admission that any of the description is prior art relative to the present invention.

### SUMMARY OF THE INVENTION

In one aspect, the invention provides a system and method for acquisition funding comprising identifying a time period associated with a contingent acquisition, and issuing a convertible security to finance the acquisition, the convertible security having a redemption right that is exercisable by an issuer of the convertible security within the time period and upon termination of the contingent acquisition. Within the time period, the system and method determine whether the contingent acquisition is terminated, and responsive to determining whether the contingent acquisition is terminated, the system and method redeem the convertible security.

In one aspect, the system and method further comprise, upon redeeming the convertible security, paying an issue price and a fixed premium to a holder of the convertible security. In one aspect, the system and method further comprise, upon redeeming the convertible security, paying an issue price, and a variable premium to a holder of the convertible security, wherein the variable premium is determined based on a change in value of the issuer's common stock. In one aspect, paying a variable premium occurs only if value of the issuer's common stock increases after issue of the convertible security. In one aspect, the system and method further comprise, upon redeeming the convertible security, paying an issue price, and a variable premium to a holder of the convertible security, wherein the variable premium is determined based on a change in value of the convertible security. In one aspect, paying a variable premium occurs only if value of the convertible security increases after issue of the convertible security. In one aspect, the system and method further comprise, upon redeeming the convertible security, paying an issue price, a fixed premium, and a variable premium to a holder of the convertible bond.

In one aspect, the invention provides a convertible security that comprises an issue price, a maturity, and an acquisition redemption right. The acquisition redemption right is exercisable by an issuer of the convertible security within a predetermined time upon termination of a contingent acquisition.

In one aspect, the convertible security further comprises terms for payment of the issue price and a fixed premium upon exercise of the acquisition redemption right. In one aspect, the convertible security further comprises terms for payment of the issue price and a variable premium upon exercise of the acquisition redemption right, wherein the variable premium is determined based on a change in value of the issuer's common stock. In one aspect, payment of the variable premium occurs only if value of the common stock increases. In one aspect, the convertible security further comprises terms for payment of the issue price and a variable premium upon exercise of the acquisition redemption right, wherein the variable premium is determined based on a change in value of the convertible security. In one aspect, payment of the variable premium occurs only if value of the convertible security increases. In one aspect, the convertible security further comprises terms for payment of the issue price, a fixed premium, and a variable premium. In one aspect, the convertible security further comprises a put option that is exercisable by a holder of the convertible security after the predetermined time. In one aspect, the convertible security further comprises a call option that is exercisable by an issuer of the convertible security after the predetermined time.

The foregoing specific aspects of the invention are illustrative of those which can be achieved and are not intended to be exhaustive or limiting of the possible advantages that can be realized. Thus, the objects and advantages of this invention will be apparent from the description herein or can be learned from practicing the invention, both as embodied herein or as modified in view of any variations which may be apparent to those skilled in the art. Accordingly, the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates a system according to one embodiment of the invention; and

FIG. 2 illustrates steps in a method according to one embodiment of the invention.

It is understood that the drawings are for illustration only and are not limiting.

### DETAILED DESCRIPTION OF THE DRAWINGS

In one embodiment the invention provides a system and method for pre-acquisition or contingent acquisition funding. The system and method help to make the convertible market more accessible and attractive to companies who are interested in acquisitions and may have need for financing.

As noted above, systems and methods for funding through convertible bonds and securities are known. For companies that have issued convertibles to raise proceeds for an anticipated acquisition, a missing feature in the known systems is the ability to call the convertibles if and at such time that the acquisition agreement is terminated and the proceeds are no longer needed.

The embodiments of the invention that are described herein help issuers wishing to raise funds for an anticipated merger to access the convertibles market by giving the issuer the flexibility to call the convertible if and when the acquisition does not occur upon the payment of a predetermined call price.

An Example System

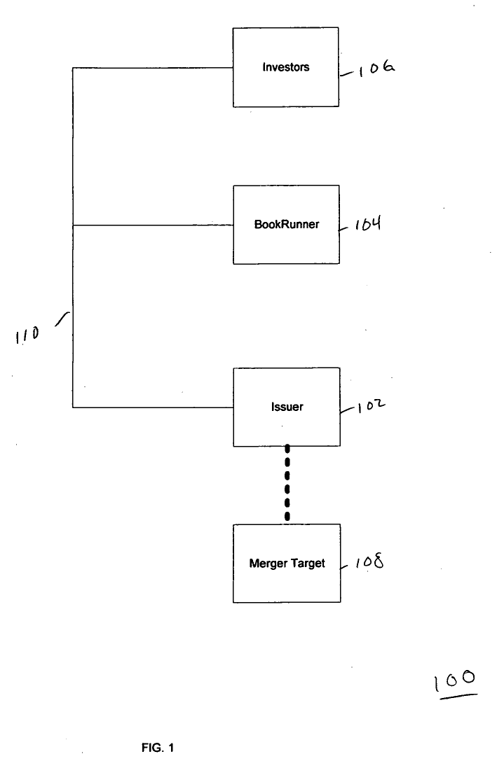

Referring to FIG. 1, system 100 according to one embodiment of the invention includes an issuer 102, a bookrunner 104, investors 106, and a merger target 108. Issuer 102 may interact with investors 106 either directly or through bookrunner 104. Although not illustrated, issuer 102, bookrunner 104, investors 106, and merger target 108 include general purpose computers that are linked by a network (LAN, WAN, intranet, extranet, PSTN, the Internet, etc.) 110. The general purpose computers include a central processor unit (CPU), memory (RAM, ROM, flash etc.), input/output devices (printer, display, keyboard, pointing device, etc.), fixed and removable storage media (hard drive, floppy drive, optical drive, etc.), and a network interface device (modem, Ethernet card, WiFi card, etc.).

An Example Method

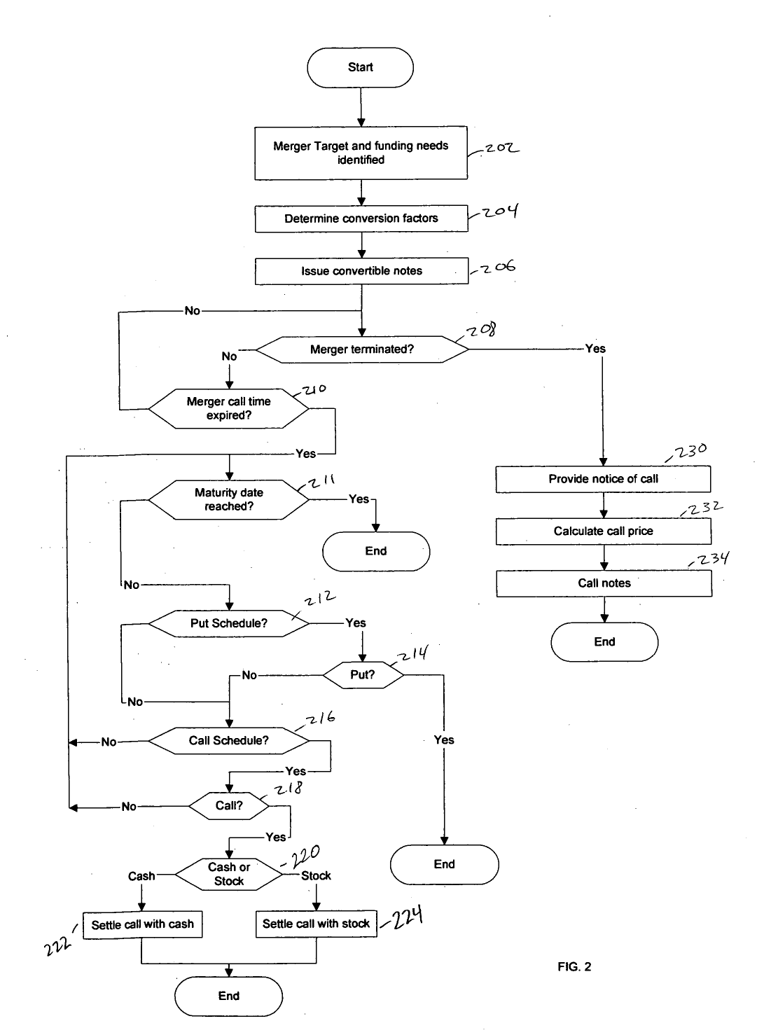

Referring to FIG. 2, one embodiment of a method according to the invention begins at step 202 where an issuer (102) identifies a merger target (108) and the associated funding needs for the merger.

At step 204, upon deciding to issue convertible securities or notes, the issuer determines the conversion factors. For example, the conversion factors include the length of time after issuance that the bond or security may be redeemed or called if the merger is terminated (the merger call period). The factors also include the redemption or call price. In one embodiment, the call price is the product of the issue price and a fixed premium, with an additional variable premium that is based on the change in value of the note if such value has increased after issuance. The conversion factors further include subsequent call and/or put schedules and the notes date of maturity.

As an example, the call or redemption price might be 102% of the issue price, plus 80% of any increase in the conversion value. In one embodiment, the conversion value is the product of a conversion rate and the average of the last reported sale price of the issuing company common stock for the immediately preceding 10 days before the redemption date. The following tables illustrate the call or redemption price that would be paid at different average stock prices.

| | |
|---|---|
| Issue price per bond or security | $1,000.00 |
| Stock price at issuance | $23.16 |
| Conversion price | $33.00 |
| Conversion rate | 30.3003 |
| Conversion Value at Issuance | $701.75 |
| Base call price | 102.0% |
| Participation rate in Conversion Value | 80% |
| Maturity | 20 years |
| Coupon | 2.50% |
| Premium | 30.00% |
| Call schedule | Non-call 7 |
| Put schedule | 7, 10, 15 |
| Redemption Call Notice | 10 days |

| Avg. Stock Price | Conversion Value | Call or Redemption Price |
|---|---|---|
| $20.00 | $606.01 | $1,020.00 |
| $22.50 | $681.76 | $1,020.00 |
| $25.00 | $757.51 | $1,064.60 |
| $27.50 | $833.26 | $1,125.20 |
| $30.00 | $909.01 | $1,185.80 |
| $32.50 | $984.76 | $1,246.40 |
| $35.00 | $1,060.51 | $1,307.00 |

At step 206, the issuer issues the convertible notes to investors (106). Once the notes have been issued, the merger call period begins. The merger call period is the time period associated with the contingent acquisition. The convertible notes include a redemption right that the issuer can exercise within the merger call period in the event that the contingent acquisition terminates.

In one embodiment, at step 208 system 100 determines whether the merger is terminated.

If at step 208 system 100 determines that the merger is terminated, then at step 230 issuer 102 provides notice to investors 106 of an intent to call the notes.

At step 232, the issuer calculates the call price. As described elsewhere, one method of determining the call price is the product of the issue price and a fixed and/or variable premium. The variable premium is calculated by taking a percentage of the change in stock price so long as there has been an increase in the price since issuance.

At step 234, the issuer calls or redeems the notes and pays the call price to the investors. The notes are then retired.

In another embodiment, if at step 208 system 100 determines that the merger is not terminated, then at step 210 system 100 determines whether the merger call period has expired. If the time for the merger call period has not expired at step 210, then system 100 loops to step 208 and the merger call provision remains callable until such time has expired or the merger has occurred.

If at step 210 system 100 determines that the merger call period has expired, then at step 211 system 100 determines whether the maturity date of the note has been reached, and if so the process ends.

If at step 211 system 100 determines that the maturity date of the note has not been reached, then at step 212 system 100 determines whether the note provides for a put option, and if so whether the put schedule so allows. If the note is puttable, then an investor can require the issuer to redeem the convertible on a predetermined date or dates prior to maturity at a fixed price. If an investor decides to exercise his or her put option at step 214, then the issuer pays the put price to the investor, the notes are retired and the process ends.

If at step 212 system 100 determines that there is no put option or at step 214 the investor chooses not to exercise the put option, then at step 216 system 100 determines whether additional calls are scheduled. As previously noted, call options subsequent to issuance but unlinked to the occurrence of corporate transactions are a common feature of convertibles.

If at step 216 system 100 determines that additional calls are scheduled, then at step 218, system 100 determines whether the issuer has decided to call the notes. If the issuer calls the notes at step 218, then the investors decide at step 220 to receive the call price or convert to stock according to the terms of the call provision.

If at step 220 system 100 determines that the investors chose to receive the call price, then at step 222 the issuer pays the price, the notes are retired and the process ends. If at step 220 system 100 determines that the investors chose to convert to stock, then at step 224 the issuer converts the investors' notes to stock, the notes are retired and the system ends.

If at step 216 system 100 determines that the notes do not provide for subsequent calls, or the issuer does not decide to call the notes at step 218, then system 100 loops to step 211, and checks to see of the convertibles have reached their date of maturity.

Although illustrative embodiments have been described herein in detail, it should be noted and will be appreciated by those skilled in the art that numerous variations may be made within the scope of this invention without departing from the principles of this invention and without sacrificing its chief advantages.

As illustrated and described above, if the contingent acquisition or merger terminates, the issuer redeems the notes. However, in another embodiment, issuer 102 does not necessarily redeem the notes upon termination of the merger or contingent acquisition.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

We claim:

1. A method for acquisition funding comprising:
identifying a time period associated with a contingent acquisition;
issuing a convertible security to finance the acquisition, the convertible security having a redemption right that is exercisable by an issuer of the convertible security within the time period and upon termination of the contingent acquisition;
determining, within the time period, whether the contingent acquisition is terminated; and
responsive to determining whether the contingent acquisition is terminated, redeeming the convertible security.

2. A method according to claim 1, further comprising, upon redeeming the convertible security, paying an issue price and a fixed premium to a holder of the convertible security.

3. A method according to claim 1, further comprising, upon redeeming the convertible security, paying an issue price, and a variable premium to a holder of the convertible security, wherein the variable premium is determined based on a change in value of the issuer's common stock.

4. A method according to claim 3, wherein paying a variable premium occurs only if value of the issuer's common stock increases after issue of the convertible security.

5. A method according to claim 1, further comprising, upon redeeming the convertible security, paying an issue price, and a variable premium to a holder of the convertible security, wherein the variable premium is determined based on a change in value of the convertible security.

6. A method according to claim 5, wherein paying a variable premium occurs only if value of the convertible security increases after issue of the convertible security.

7. A method according to claim 1, further comprising, upon redeeming the convertible security, paying an issue price, a fixed premium, and a variable premium to a holder of the convertible bond.

8. A method for contingent acquisition finding comprising:
identifying a predetermined time period associated with the contingent acquisition;
issuing a convertible bond to finance the contingent acquisition, the convertible bond having a call option that is exercisable by an issuer of the convertible bond within the predetermined time period and upon termination of the contingent acquisition;
determining, within the predetermined time period, whether the contingent acquisition is terminated;
responsive to determining whether the contingent acquisition is terminated, redeeming the convertible bond, wherein redeeming the convertible bond comprises:
paying an issue price of the convertible bond;
paying a fixed premium; and
paying a variable premium that is a percentage increase in value of the issuer's common stock.

9. A convertible security comprising:
an issue price;
a maturity; and
an acquisition redemption right, wherein the acquisition redemption right is exercisable by an issuer of the convertible security within a predetermined time upon termination of a contingent acquisition.

10. A convertible security according to claim 9, further comprising terms for payment of the issue price and a fixed premium upon exercise of the acquisition redemption right.

11. A convertible security according to claim 9, further comprising terms for payment of the issue price and a variable premium upon exercise of the acquisition redemption right, wherein the variable premium is determined based on a change in value of the issuer's common stock.

12. A convertible security according to claim 11, wherein payment of the variable premium occurs only if value of the common stock increases.

13. A convertible security according to claim 9, further comprising terms for payment of the issue price and a variable premium upon exercise of the acquisition redemption right, wherein the variable premium is determined based on a change in value of the convertible security.

14. A convertible security according to claim 13, wherein payment of the variable premium occurs only if value of the convertible security increases.

15. A convertible security according to claim 9, further comprising terms for payment of the issue price, a fixed premium, and a variable premium.

16. A convertible security according to claim 9, further comprising a put option that is exercisable by a holder of the convertible security after the predetermined time.

17. A convertible security according to claim 9, further comprising a call option that is exercisable by an issuer of the convertible security after the predetermined time.

18. A convertible bond comprising:
an issue price;
a maturity; and
a call option, wherein the call option is exercisable by an issuer of the convertible bond within a predetermined time upon termination of a contingent acquisition and comprises:
terms for payment of the issue price;
terms for payment of a fixed premium; and
terms for payment of a variable premium that is a percentage increase in value of the convertible bond issuer's common stock.

19. A system for acquisition finding comprising:
means for identifying a time period associated with a contingent acquisition;
means for issuing a convertible security to finance the acquisition, the convertible security having a redemption right that is exercisable by an issuer of the convertible security within the time period and upon termination of the contingent acquisition;
means for determining, within the time period, whether the contingent acquisition is terminated; and
responsive to means for determining whether the contingent acquisition is terminated, means for redeeming the convertible security.

20. Computer executable software code transmitted as an information signal, the code for acquisition funding, the code comprising:
code to identify a time period associated with a contingent acquisition;
code to issue a convertible security to finance the acquisition, the convertible security having a redemption right that is exercisable by an issuer of the convertible security within the time period and upon termination of the contingent acquisition;
code to determine, within the time period, whether the contingent acquisition is terminated; and
responsive to code to determine whether the contingent acquisition is terminated, code to redeem the convertible security.

21. A computer-readable medium having computer executable software code stored thereon, the code for acquisition funding, the code comprising:
code to identify a time period associated with a contingent acquisition;
code to issue a convertible security to finance the acquisition, the convertible security having a redemption right that is exercisable by an issuer of the convertible security within the time period and upon termination of the contingent acquisition;
code to determine, within the time period, whether the contingent acquisition is terminated; and
responsive to code to determine whether the contingent acquisition is terminated, code to redeem the convertible security.

22. A programmed computer for acquisition funding, comprising:
a memory having at least one region for storing computer executable program code; and
a processor for executing the program code stored in the memory, wherein the program code comprises:
code to identify a time period associated with a contingent acquisition;
code to issue a convertible security to finance the acquisition, the convertible security having a redemption right that is exercisable by an issuer of the convertible security within the time period and upon termination of the contingent acquisition;
code to determine, within the time period, whether the contingent acquisition is terminated; and
responsive to code to determine whether the contingent acquisition is terminated, code to redeem the convertible security.
